(19) United States
(12) Patent Application Publication
(10) Pub. No.: US 2003/0145101 A1
(43) Pub. Date: Jul. 31, 2003

(54) Reduction of resource usage in TCP/IP implementation

(76) Inventors: Stuart Mitchell, Elvington (GB); John Tuffen, York (GB); Kenneth Tindall, Naburn (GB)

Correspondence Address: SHERIDAN ROSS PC, 1560 BROADWAY, SUITE 1200, DENVER, CO, 80202

(21) Appl. No.: 10/191,875

(22) Filed: Jul. 8, 2002

Related U.S. Application Data
(60) Provisional application No. 60/310,885, filed on Aug. 8, 2001.

(30) Foreign Application Priority Data
Jul. 6, 2001 (GB) 0116549.7

(51) Int. Cl. G06F 15/16

(52) U.S. Cl. 709/236; 709/226

(57) ABSTRACT

An embedded computing device and method for its use, the embedded computing device including a server application for receiving data transmitted to the embedded computing device under TCP/IP, wherein the server application is adapted to extract and buffer only predetermined portions of the transmitted data which are necessary for correct operation of the embedded computing device. There is further disclosed an embedded computing device and method for its use, the device being adapted to transmit data under TCP/IP, which data is too large to be held by available RAM in the embedded computing device, wherein the embedded computing device is adapted to intermix dynamic data content which must be held in RAM with static data content which is held in ROM, and to separate the dynamic data held in RAM from the static data content held in ROM by way of a predetermined off-line calculation mechanism which generates discrete data packets each of which will fit into an MTU (Maximum Transmission Unit).

### CROSS REFERENCE TO RELATED APPLICATIONS

This application claims priority from UK Patent Application No. 0116549.7 filed on Jul. 6, 2001 and from U.S. Provisional Patent Application No. 60/310,885 filed in Aug. 8, 2001 entitled “Improvements Relating to Reduction of Resource Usage in TCP/IP Implementation”. The entire disclosure of the U.S. provisional application is considered to be part of the disclosure of the accompanying application and is hereby incorporated by reference.

### FIELD OF THE INVENTION

The present invention relates to methods and software for reducing resource usage in TCP/IP (Transmission Control Protocol/Internet Protocol) implementation.

### BACKGROUND OF THE INVENTION

Recently, there has been much development in the field of embedded devices adapted to be connected to the Internet or similar. Such an embedded device is generally in the form of a microcontroller adapted to interact with a larger server or servers, thereby allowing a device (such as a vending machine, domestic electric appliance, motor vehicle etc) to be remotely controlled and/or monitored from a central server by way of a standard protocol such as Internet Protocol.

A major difficulty with embedded devices is that they generally comprise microcontrollers or the like with very limited RAM and ROM. A typical microcontroller for use as an embedded device may have 32 kB of ROM and 1 kB of RAM, which is not enough to support the usual implementations of communications protocols such as TCP/IP. The characteristics of these devices are such that conventional implementations (such as those described in Gary R Wright and W Richard Stevens, “TCP/IP Illustrated Volume 2: The Implementation”, Addison-Wesley Professional Computing Series, 1995) of Internet Protocols (“IP”) and the layered protocols such as Transmission Control Protocol (“TCP”) or User Datagram Protocol (“UDP”), as well as higher-level application protocols such as HTTP, FTP, Telnet etc. are not feasible as they would demand more RAM or ROM than is typically available on the device.

It is particularly desirable to enable feature-rich communication to and from embedded devices, but this is currently not achievable because of the limited memory of such devices.

### SUMMARY OF THE INVENTION

According to a first aspect of the present invention, there is provided an embedded computing device including a server application for receiving data transmitted to the embedded computing device under TCP/IP, wherein the server application is adapted to extract and buffer only predetermined portions of the transmitted data which are necessary for correct operation of the embedded computing device.

According to a second aspect of the present invention, there is provided a method of processing data transmitted to an embedded computing device under TCP/IP, wherein a server application provided in the embedded computing device is adapted to scan the transmitted data and to extract and buffer only predetermined portions of data which are necessary for correct operation of the embedded computing device.

In a conventional TCP/IP implementation, data is transmitted in segments such as IP packets, each of which comprises a short header including identification data, and a payload typically of 50 to 1500 bytes. Application data is transmitted using TCP, which uses a form of packet switching which allows a string of data to be split between many different IP packets, transmitted separately over the Internet to a remote server, and then reassembled in the correct order at the remote server. Generally, each incoming IP packet is buffered by the remote server, a checksum calculation is made to identify possible data corruption, and the payload of the IP packet is then passed to an application served by the remote server. However, many data communications under TCP/IP include a large amount of irrelevant data which nevertheless needs to be buffered, which requires a significant amount of RAM. For example, an HTTP request generally includes a vast amount of superfluous data in addition to a URL or filename, which is generally the only information that is required by an embedded device receiving an HTTP request. A conventional TCP/IP stack is operable only to receive and buffer the entire IP packet containing the HTTP request.

Accordingly, by programming an embedded computing device with a server application configured to extract and buffer only the predetermined parts of an IP packet or packets that are necessary for correct operation of the embedded computing device (e.g. a URL or filename), it is possible to checksum and discard the remaining data in the IP packet or packets, thereby avoiding the need for a large amount of RAM with which to buffer data which is of no relevance.

It is to be appreciated that an embedded computing device in the context of the present application comprises a hardware component or components (e.g. a microcontroller) and a software component or components (e.g. a server application). The software component (e.g. a server application) further includes a TCP/IP stack as defined hereinbelow, and is adapted to control the operation of the hardware component.

Received data is passed to an application task in chunks (which are of variable size, depending on the underlying datalink MTU, available RAM, and other factors). This allows received messages of arbitrary size to be passed to application tasks.

Only the “interesting” (i.e. necessary for correct operation) data components are buffered by the server application receiving the data. Internet protocols are often very verbose (e.g. an HTTP request can consist of many hundreds of characters just to convey a filename of a few characters). The application is able to extract the necessary information as it is presented, whereas the TCP/IP stack cannot do so and would otherwise have to buffer the entire message.

The checksum can only be tested at the end of a received segment. A received message can be split across several TCP segments. One event that the stack notifies to the task serving a connection is that segment reception is complete, with an indication of whether the checksum test passed or failed. The present applicant has developed a server task structure that makes use of this information to checkpoint its state when a segment is notified as received with checksum OK, and to roll back to the last checkpoint when the start of a segment is notified (an implementation with equivalent functionality is to roll back when an incorrect checksum is notified). The result is that the server task will correctly build up its buffer of “interesting” received data even when some segments in the reception sequence are first received in corrupted form then re-received correctly (the re-transmit mechanism is part of TCP). FIGS. 1 to 5 of the accompanying drawings illustrate this process.

In addition to the problems involved in receiving and processing data with an embedded computing device, for example a microcontroller, having limited memory size, there are problems associated with transmitting data therefrom.

According to a third aspect of the present invention, there is provided an embedded computing device adapted to transmit data under TCP/IP, which data is too large to be held by available RAM in the embedded computing device, wherein the embedded computing device is adapted to intermix dynamic data content which must be held in RAM with static data content which is held in ROM, and to separate the dynamic data held in RAM from the static data content held in ROM by way of a predetermined off-line calculation mechanism which generates discrete data packets each of which will fit into an MTU (Maximum Transmission Unit).

According to a fourth aspect of the present invention, there is provided a method of transmitting data from an embedded computing device under TCP/IP, which data is too large to be held by available RAM in the embedded computing device, wherein dynamic data content which must be held in RAM is intermixed with static data content which is held in ROM, and wherein the dynamic data held in RAM is then separated from the static data content held in ROM by way of a predetermined off-line calculation mechanism which generates discrete data packets each of which will fit into an MTU (Maximum Transmission Unit).

Dynamic content which must be held in RAM is intermixed with static content held in ROM (microcontrollers and the like used in embedded systems typically have much more ROM than RAM). This is implemented using the off-line calculation mechanism described in connection with the ninth and tenth aspects of the present invention below to segment the ROM-only and RAM-only parts into discrete chunks that will each fit into an MTU. Several implementations of the data storage are possible, selected according to particular application needs (e.g. linked lists, hash tables or trees of elements).

Application specific update of dynamic outgoing content embedded in files (whose size may be much larger than available RAM) may be made by callbacks to user supplied code (e.g. updates of web pages, ftp (File Transfer Protocol) readout, etc.).

“Active Files” connect arbitrary application behaviour to the transmission of outgoing messages. This is achieved by associating callback functions with files. When a file is read, the callback function is invoked before the file content is obtained. The user is free to implement any application behaviour in the callback. For example, a file may exist in a simple ROM-based filesystem, but may contain a callback giving some dynamic content:

file “myfile.txt” {

text “<html><head><title>Hello World</title></head>”;
text “<body>This is an embedded HTML file.”;
text “You are visitor number ”;
call count_visitor( );
text “</body></html>”;

}

As the file is read by the underlying filesystem layer, the “text” elements are passed one by one to the application. When the file has been read up to the point where the “call” declaration is found, the named function is called and the results of that transparently interpolated in the output (the TCP/IP stack and application code are unaware that any interpolation has taken place). One mechanism that is implemented using these callbacks is application specific update of dynamic outgoing content embedded in files (e.g. updates of web pages, ftp readout etc). The dynamic content is inserted as required by the application immediately before the data is queued for transmission. It is also possible to embed function calls inside “active files” that do not create any output but affect the state of some other part of the system—for example, a web page which when read has the side effect of calling a procedure to turn on some LEDs:

file “lightson.html” {

text “<html><head><title>Turning the lights

on</title></head>”;

text “<body>The lights should now be on.”;
call set_lights(ALL_LEDS_ON);
text “</body></html>”;

}

}

Embodiments of the present invention may also have application in negotiating Point-to-Point Protocol (PPP) options. PPP is typically used to encapsulate TCP/IP when sent over serial (e.g. modem) data links. PPP features many options governing the control of the data link. The present applicant has invented an economical way of negotiating these options.

In existing systems, during link negotiation, a remote host may offer many PPP options in a single message. It is likely that many of these will be irrelevant or even unacceptable to the local system. Conventional practice dictates that all such options are collected during the negotiation phase, and rejected in one message. This means that the buffer space required to hold the options is effectively unbounded (it is not known in advance which options will be offered, and hence it is not known in advance how many of the options one might want to reject). This could be coded as:

list of options to NAK = NULL;
if (options to process) then

for each option presented

if (accept this option) then

- - processing related to accepting option
elided

else

append option to list of options to NAK

end if;

end for;
for each option to reject

construct and transmit a reject for that option

end for;

end if;

According to a fifth aspect of the present invention, there is provided an embedded computing device adapted to negotiate PPP (Point-to-Point Protocol) options under TCP/IP by sending explicit reject and NAK (Negative AcKnowledge) messages as soon as a PPP option is received.

According to a sixth aspect of the present invention, there is provided a method of negotiating PPP (Point-to-Point Protocol) options under TCP/IP in an embedded computing device by sending explicit reject and NAK (Negative AcKnowledge) messages as soon as a PPP option is received.

By sending explicit reject and NAK messages as soon as an option is received rather than buffering and then rejecting all offered but unacceptable options in a single reply the present applicant can significantly reduce RAM storage overheads so as to enable implementation where it would not otherwise fit due to resource constraints.

The algorithm below illustrates this—compare noting in particular that the storage needed is bounded—only one option is ever pending at any time.

if (options to process) then

for each option presented

if (accept this option) then

- - processing related to accepting option
elided

else

construct and transmit a reject for that

option

end if;

end for;

end if;

Embodiments of the present invention may further provide a mechanism by which application tasks running on an embedded computing device consume no dynamic resources except when dealing with communications activity.

In a conventional TCP/IP implementation, worker tasks are spawned when the system starts up. Worker tasks are generally running all of the time, calling a variety of “blocking” API calls that cause the task to suspend when data or network access is not yet available. Furthermore, they continuously consume dynamic resources (RAM for stack space, entries in queues etc.). Since the nature of communications activity is sporadic, these tasks have to call on the services provided by the TCP/IP implementation and then wait (holding resources as just noted) until the results of those service requests are returned.

For example, consider a task in a typical multi-tasking operating system that wishes to read data from a TCP/IP connection. This would typically be coded in the form described below:

task worker_task (c : in net_connection) is
begin

data : string;
while (still_more_data_to_read) do

net_read (data, net_connection);
process (data);
- - further detail elided

end while;

end task;

In a typical operating system, the task would “block” in the “net_read” call until some data was available—hence would still be consuming stack space and other dynamic resources.

According to a seventh aspect of the present invention, there is provided an embedded computing device operating under TCP/IP in which an application task consumes no dynamic resources except when dealing with communications activity, wherein the embedded computing device is adapted to associate the application task as a servant for a connection such that the application task is passive until its execution is triggered by activity on the connection served.

According to an eighth aspect of the present invention, there is provided a method of operating an embedded computing device under TCP/IP such that an application task consumes no dynamic resources except when dealing with communications activity, wherein the embedded computing device is adapted to associate the application task as a servant for a connection such that the application task is passive until its execution is triggered by activity on the connection served.

In contrast to existing systems, the present applicant associates application tasks as “servants” for connections. This allows the tasks to be completely passive (i.e not in the operating system's “waiting” or “blocked” state) until their execution is triggered by activity on the connection that they serve. The tasks are implemented in a single-shot execution model (such as that mandated by conformance classes BCC1 and BCC2 of the OSEK operating system specification [OSEK. VDX Operating System Version 2.1 revision 1, Nov. 13, 2000, see http://www.osek-vdx.org/], so they consume no dynamic resources except when activated.

For example, one might declare the following in a (hypothetical) operating system configuration file:

connection c1 {

listen on ip 192.168.1.1 port 80;
activate task c1_worker;

}

When an event (e.g. the arrival of some data, or indication that the connection should close) is received on such a bound connection, the corresponding task(s) are activated and must decode the flags indicating which actions are to be taken, for example:

task c1_worker (flags : in net_flags) is

data : string;
if (flags.DATA_READY = true) then

net_read(data);
process(data);
- - further detail elided

end if;
if (flags.DATA_COMPLETE = true) then

- - take appropriate action; further detail elided

end if;
if (flags.CLOSE_CONNECTION = true) then

- - take appropriate action; further detail elided

end if;
- - further actions elided.

end task;

When a task is activated by communications events, the event types are communicated to the task by a set of flags. This allows a task to serve several events in a single activation (e.g. that a connection has been established by an outside request, that data is now available sent from the requester, and that the data is complete), and the task implementation is structured to deal with simultaneous notification of multiple events. By contrast, the conventional model typically has a task wait for and consume a single event at a time.

Embodiments of the present invention may further provide a mechanism by which communication session characteristics are pre-computed off-line to reduce run-time storage size and execution time.

In typical TCP/IP implementations, many aspects of the communications session are determined dynamically, derived from the application data and other information involved in the communication. Such aspects include:

Checksum values. TCP/IP communication is protected against data corruption by means of a checksums used by the receiver to detect such corruption. Typical implementations of the TCP/IP protocol stack calculate this “on the fly” for all data sent.

Bound Connections. In conventional operating systems and TCP/IP stacks, the association between a server and the port on which it listens is made at runtime by an explicit API call, and a connection control block is typically created via dynamic memory allocation mechanisms. Such dynamic-memory allocation mechanisms may be unavailable or extremely expensive on small microcontrollers. For example, in a typical operating system (OS) one might see a code fragment such as:

task http_server is

- - memory allocation here
c = new connection_buffer;
- - dynamic API call to bind - may allocate more memory
bind (c, PROTOCOL_TCP, 80, “192.168.1.1”)
while (is_open(c) ) do

web_page p = get_request(c);
serve_page (p);

end while
close (connection => c)

end task;

Segmentation of messages. The maximum size of a single segment carried by TCP/IP is limited by the datalink Maximum Transmission Unit (“MTU”: the largest possible message that can be sent down the transmission medium in one unit). Typical TCP/IP implementations dynamically segment messages based on the MTU.

According to a ninth aspect of the present invention, there is provided an embedded computing device adapted to utilise pre-computed TCP/IP communication session characteristics determined off-line, the characteristics comprising pre-calculated and stored partial checksums taken over static sections of data to be transmitted, wherein the embedded computing device combines pre-calculated partial checksum data with checksum data calculated for dynamic data content when transmitting data.

According to a tenth aspect of the present invention, there is provided a method of operating an embedded computing device whereby TCP/IP communication session characteristics are pre-computed off-line by pre-calculating and storing partial checksums over static sections of data to be transmitted, and wherein the embedded computing device then combines pre-calculated partial checksum data with checksum data calculated for dynamic data content when transmitting data.

The present applicant has developed a novel approach in which the run-time communication behaviour is flexible (connection destinations, data content etc. are dynamic) but run-time savings are made by identifying and acting on information which is known in advance to be static. With reference to the points made above:

Checksum values. The TCP checksum algorithm is a simple negated 16-bit ones-complement of the data sent. It has the property that the checksums for any two strings A and B may be trivially combined to form a valid checksum for the string AB. Whereas in a conventional TCP/IP stack the checksum for the string AB would be recalculated from scratch whenever data is sent, embodiments of the present invention exploit the properties of the checksum algorithm in such a way that it is possible to combine pre-calculated fragments of checksum for known or predetermined data. Partial checksums are pre-calculated over sections of data and/or header information where the exact content is known. The pre-calculated partial checksums are then combined with the checksum information (calculated on the fly) for any dynamic content when output is generated. This greatly reduces the run-time computational overhead that would otherwise arise to checksum the static content.

In the case of known or predetermined data, the pre-calculation of checksum fragments may be performed off-line and the results installed into the embedded computing device. For example, a computer program (“configuration tool”) running on a PC or similar could examine the static data and perform the pre-calculation.

Additionally or alternatively, the embedded computing device could perform pre-calculation of checksum fragments on any data once its value becomes known. This confers several advantages, including that calculation is performed once for data that might be transmitted many times, and that calculation can take place when processing resources are available, reducing load when transmission actually takes place.

According to an eleventh aspect of the present invention, there is provided an embedded computing device adapted for connection to a network by way of a plurality of connections, wherein the embedded computing device is programmed so as to make use of advanced knowledge of which of the plurality of connections it will use by default to listen for incoming data communication in order automatically to bind to those connections without any run-time application intervention.

According to a twelfth aspect of the present invention, there is provided a method of connecting an embedded computing device to a network by way of at least one of a plurality of connections, wherein the embedded computing device is programmed so as to make use of advanced knowledge of which of the plurality of connections it will use by default to listen for incoming data communication in order automatically to bind to those connections without any run-time application intervention.

Bound Connections. Connections that are used to provide services (e.g. an HTTP web server listening on port 80) must be bound to the port to become “active listeners”. By capturing this information off-line, it is possible to automatically bind such connections at startup, removing the overhead associated with executable initialization code to perform the bind operation. Connection control blocks are statically allocated (since it is known in advance how many of them there must be and what they must consist of). They may even be placed directly in ROM if there no variable fields in the control block. For example, in an offline configuration tool, the user declares:

connection web {

listen on ip 192.168.1.1 port 80;
activate task http_server;

}

and then declares the task body (using the single-shot paradigm described above in connection with the seventh and eighth aspects of the present invention) as:

task http_server (flags : in net_flags) is

if (flags.DATA_READY = true) then

u : url;

net_read(u);

serve_page(u);
- - further detail elided

end if;

- - further detail elided
end task;

The runtime startup code initialises the connection control block along with all other initialised data in the system; the connection is established and “listening” as soon the TCP/IP stack is initialised, and the task is activated whenever an event occurs on the connection, thereby saving the memory used in the binding calls and dynamic creation of the connection control block. This automatic binding of listeners is also advantageous in that it means the connection is ready to serve requests as soon as the datalink is established.

According to a thirteenth aspect of the present invention, there is provided an embedded computing device including a server application and an off-line software tool, the embedded computing device being adapted send outgoing messages over a data link, wherein the off-line software tool is adapted to pre-segment the outgoing messages into segments which fit within a predetermined MTU limit of the data link so that the messages can be transmitted piece-wise without buffering.

According to a fourteenth aspect of the present invention, there is provided a method of sending messages from an embedded computing device over a data link, the embedded computing device including a server application and an off-line software tool, wherein the off-line software tool pre-segments outgoing messages into segments which fit within a predetermined MTU limit of the data link so that the messages can be transmitted piece-wise without buffering.

Segmentation of messages. Off-line knowledge of the MTU value and the element structure for outgoing messages is combined in order to partition large messages into segments that fit within the MTU. This avoids the run-time cost that would otherwise be associated with dynamic checking and partitioning to observe the MTU if message data was just “streamed” out.

For example, consider a datalink with an MTU that allows (after all headers have been taken into account) 10 bytes of data per segment. In an offline configuration tool embodying aspects of the present invention, large messages are automatically segmented into a set of discrete “chunks” that can be passed to the TCP/IP stack whole—there is no thus need to buffer outgoing data.

For example the following unsegmented message is longer than the MTU. To send it, a typical TCP/IP stack requires a buffer of size equivalent to the MTU to break it into chunks that fit into a segment.

message m {

“now is the time for all good men to come to the aid of the party.”;
}
Since it is desired to avoid the need for buffering, the message is
transformed to:
message m1 {

chunk “Now is the”; - - guaranteed to fit inside MTU
chunk “time for a”;
chunk “ll good me”;
chunk “n to come ”;
chunk “to the aid”;
chunk “of the par”;
chunk “ty.”;

It is then necessary to iterate over the chunks, copying each of them (e.g. directly out from ROM) directly to the data link. The data can then be spooled chunk-by-chunk without a buffer, as it is guaranteed that each chunk constitutes a “full” TCP/IP segment in its own right.

In addition, it is possible to create outgoing message/chunk structures to support the transmission of large messages with dynamic content as described in connection with the third and fourth aspects of the present invention above.

### BRIEF DESCRIPTION OF THE DRAWINGS

For a better understanding of the present invention and to show how it may be carried into effect, reference shall now be made by way of example to the accompanying drawings, in which:

FIGS. 1 to 5 illustrate processing of a multi-segment payload in accordance with an embodiment of the present invention;

FIG. 6 is a flowchart relating to an off-line tool of an embodiment of the present invention;

FIG. 7 illustrates how dynamic content held in RAM is intermixed with static content held in ROM to form an IP packet in accordance with embodiments of the present invention;

FIG. 8 illustrates how a server/embedded application of an embodiment of the present invention may extract and buffer only relevant parts of an IP packet; and

FIG. 9 is a flowchart relating to data buffering and processing in a TCP/IP implementation.

### DETAILED DESCRIPTION OF THE DRAWINGS

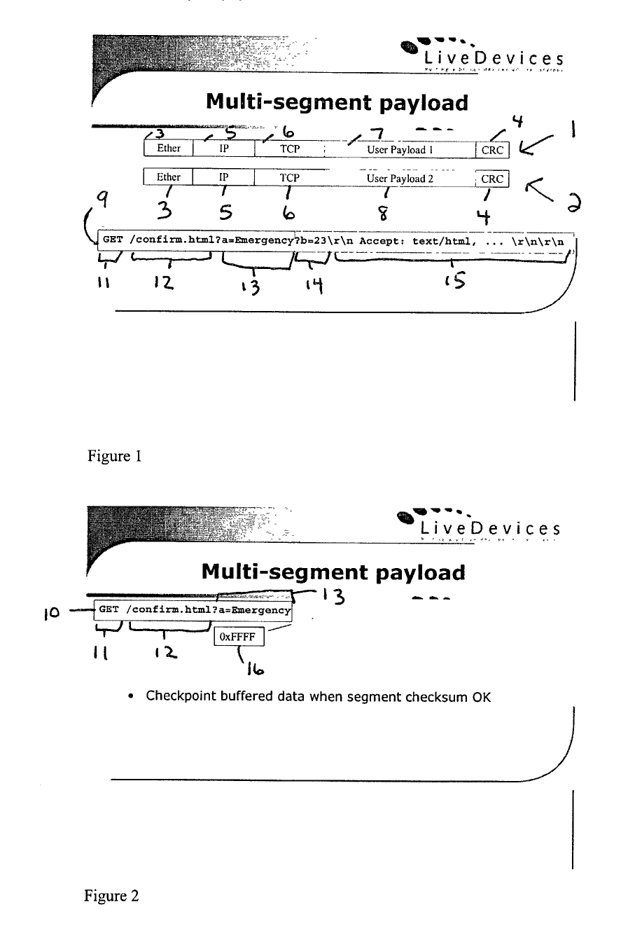

FIG. 1 illustrates a pair of IP packets 1, 2 in a conventional format as would be transmitted over the Internet. Each packet has an Ethernet header 3 and footer 4, IP data 5, TCP data 6 and a user payload 7, 8. In a standard TCP/IP implementation, the user payloads 7 and 8 are received and buffered in full in buffer 9. Specifically, user payload 7 comprises a type 11 (“GET”), a file 12 (“/confirm.html”) and a variable 13 (“?a=Emergency”); and user payload 8 comprises a variable 14 (“?b=23”) and further data 15 which is not of relevance to this discussion, except in that it is not required by the embedded devices of embodiments of the present invention. A large device has sufficient memory to buffer and process user payloads 7, 8 in their entirety in a single buffer 9, but an embedded device has insufficient memory to perform this task.

FIG. 2 illustrates how user payload 7 may be processed by way of embodiments of the present invention in a buffer 10. A server application or protocol specific state machine or the like of an embodiment of the present invention selects only those parts of the payload 7 shown here in black, while discarding those parts of the payload shown here in grey, leaving only the black parts in the buffer 10 (which may be significantly smaller than a buffer 9 of a conventional system). Specifically, the server application or the like strips out from the payload 7 the character “G” from the type 11, the name “confirm.html” from the file 12, and the variable name “a” and its value “Emergency” from the variable 13, since these are all that are needed by an embedded device. The remaining information shown in grey is discarded.

The server application or the like is able to confirm correct reception of the necessary parts of user payload 9 by way of a checksum calculation in accordance with standard TCP/IP techniques that will be known to the skilled reader. If the checksum value 16 is found to be correct (e.g. has a hexadecimal value of FFFF), it may be assumed that the stripped user payload 9 has been correctly received and buffered by the server application or the like, and a checkpoint is set in the buffer.

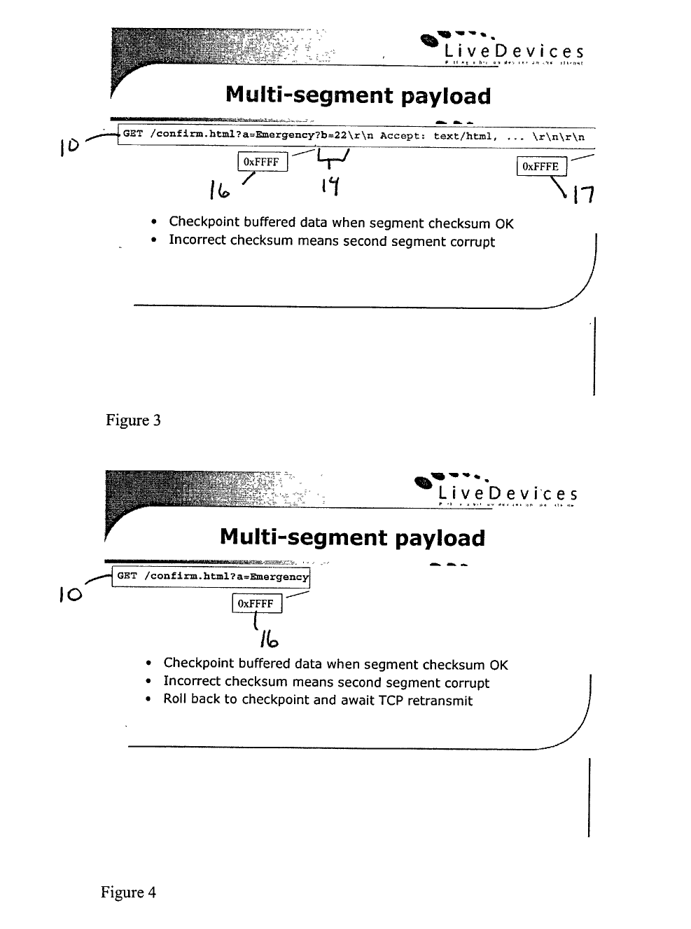

FIG. 3 illustrates how user payload 8 is processed and added to the buffer 10. The only information (shown in black) needed by the embedded device is variable name “b” and its value “23” (see FIG. 1). However, if IP packet 2 and its user payload 8 have become corrupted during transmission, illustrated here by way of variable 14 being received as “?b=22” rather than “?b=23”, then checksum value 17 is determined to be incorrect (e.g. FFFE rather than FFFF). The server application or the like will therefore know that user payload 8 has been corrupted, and will remove the received parts of the payload 8 from the buffer 10 and roll back to the checkpoint as shown in FIG. 4. It is important to appreciate that when the checksum is found to be incorrect, the IP packet 2 and its payload 8 are simply not acknowledged, which in a standard TCP/IP implementation means that IP packet 2 and its payload 8 will automatically be retransmitted again. Because a checkpoint has already been set in the buffer 10, it is easy to roll back thereto and to await retransmission without affecting the information already buffered from user payload 7.

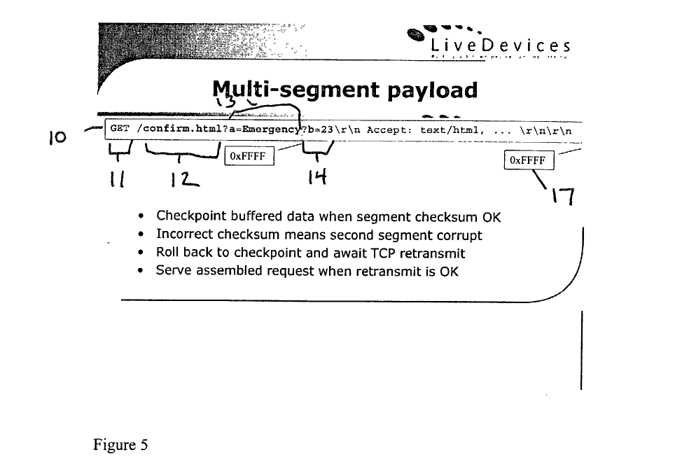

FIG. 5 shows correct reception of retransmitted IP packet 2 and its user payload 8. Variable 14 is correctly received as “?b=23”, the checksum value 17 is correctly calculated as FFFF and the variable name “b” and its value “23” are added to the buffer 10, with the irrelevant data (shown in grey) being discarded. Once all the relevant data has been assembled in buffer 10, it can be served to the embedded device for processing.

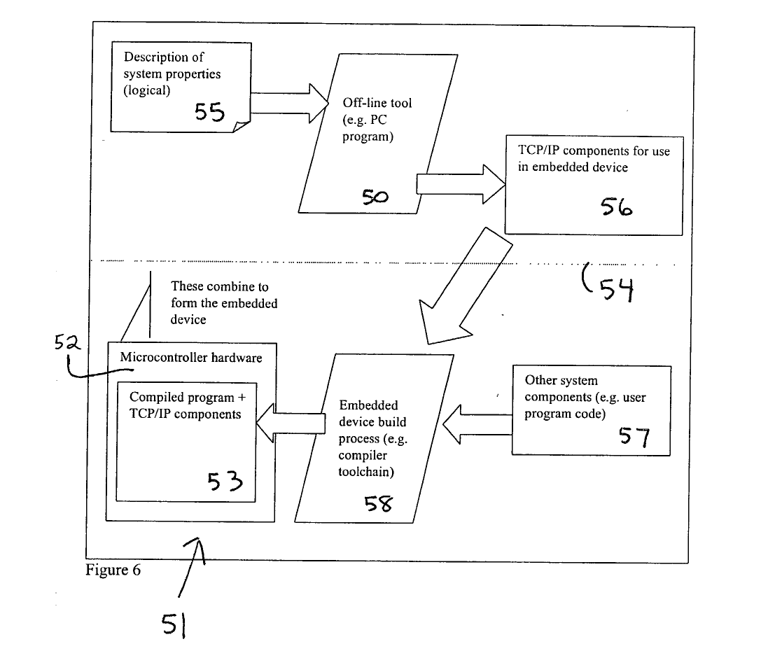

FIG. 6 illustrates off-line calculation and processing aspects of embodiments of the present invention, and demonstrates use of an off-line tool for use with the embedded computing devices described hereinbefore. Specifically, FIG. 6 illustrates the relationships and flow of data involving an off-line tool 50 as referred to above to generate components related to TCP/IP that are acted upon by an embedded computing device 51 comprising, for example, microcontroller hardware 52 and compiled program and TCP/IP components 53.

The part of the drawing above the dotted line 54 in FIG. 6 indicates that the off-line tool 50 translates from an abstract (user-domain, human readable) system description 55 to generate a representation of components 56 suitable for inclusion in the embedded computing device 51. This translation process adds many novel optimisations to the system representation 55, as described elsewhere in the present application.

The part of the drawing below the dotted line 54 in FIG. 6 shows one way in which the off-line tool 50 can fit into a conventional software development process for embedded computing devices 51. It is illustrative rather than prescriptive. The generated components 56 for use in the embedded device 51 may be passed, together with additional system components 57 (for example, user program code and the like), to an embedded device build process 58 (for example, a compiler toolchain), the output of which forms the compiled program and TCP/IP components 53 making up the software components of the embedded device 51.

The description of the system properties 55 might take one or more of several possible forms. Examples are some textual form such as the examples used elsewhere, or a data capture and presentation using a GUI (Graphical User Interface). The content of the system description 55 can include (but is not limited to) some or all of the properties described elsewhere in the present application (connections whose pre-binding is desired, data for transmission [“messages”] with an indication of their static and dynamic components, indication of active files and their associated callbacks etc.).

The generated components 56 can include (but are not limited to) some or all of the embedded device components described elsewhere in the present application (e.g. constant parts of messages and their associated partial checksums, pre-initialisation of connection bindings, messages partition to fit within MTU).

Various algorithms within the off-line tool 50 create the components 56 required by the aspects of the present invention described elsewhere in the present application. The off-line tool 50 thus forms a convenient means to deploy these aspects of the invention.

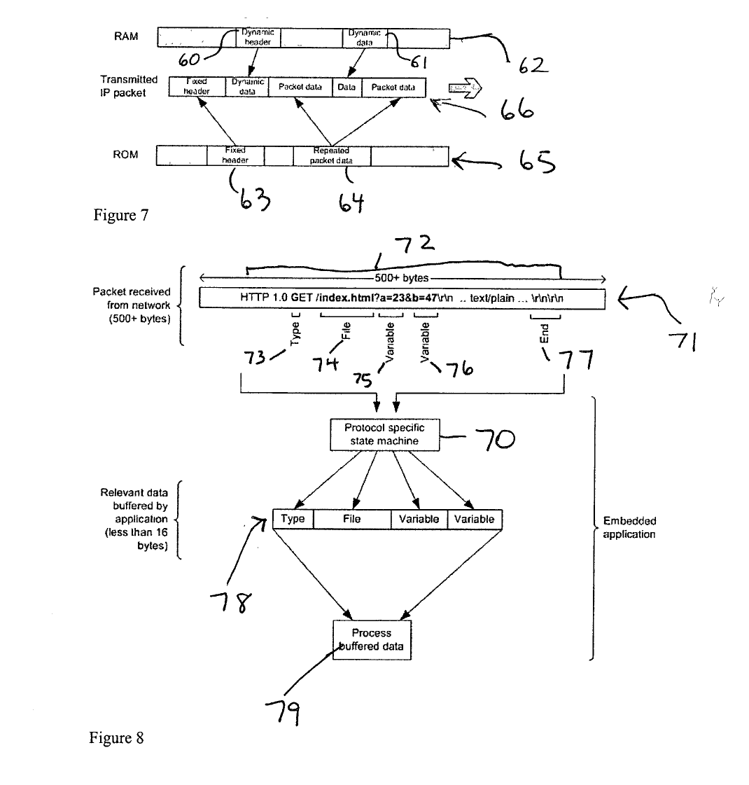

FIG. 7 illustrates how dynamic content 60, 61 held in RAM 62 of an embedded device is intermixed with static content 63, 64 held in ROM 65 of the embedded device to form an IP packet 66 for transmission over the Internet or the like. The dynamic content may include a dynamic header 60 and dynamic data 61, and the static content may include a fixed header 63 and repeated packet data 64. An off-line calculation mechanism, for example as described in relation to the ninth and tenth aspects of the present invention, or the off-line tool 50 described in relation to FIG. 6, selects the content components 60, 61, 63 and 64 in such a way that each component comprises a data packet that will fit into an MTU. The components 60, 61, 63 and 64 are then assembled in an appropriate order by the off-line calculation mechanism or tool into an IP packet 66. It is to be appreciated that the content 60, 61, 63, 64 is not buffered, as would be the case in a conventional implementation, but is directly copied from RAM 62 and/or ROM 65 to form the IP packet 66 in a “byte on demand” manner. Accordingly, there is no need to provide additional memory means in the embedded device in order to buffer the data making up the IP packet 66; additionally, there may be a time saving because it is not necessary to assemble the IP packet 66 in a buffer before transmission.

FIG. 8 shows how a server/embedded application 70 (e.g. a protocol specific state machine) of an embodiment of the present invention may extract and buffer only relevant parts of a conventional IP packet 71. The conventional IP packet 71 (which in this example is a Web page request) is typically over 500 bytes in length, and includes one or more headers (not shown) and a payload 72 (cf. FIG. 1). The payload 72 includes a type 73 (“GET”), a file 74 (“/index.html”) and variables 75 (“?a=23”) and 76 (“?b=47”) together with termination indicators 77. A large device has sufficient memory to buffer and process user payload 72 in its entirety in a single buffer, but an embedded device has insufficient memory to perform this task. Accordingly, only relevant parts of the payload 72 (here shown in solid black) are selected by the protocol specific state machine 70 of an embedded device of an embodiment of the present invention, while discarding those parts of the payload 72 shown here in grey, leaving only the black parts in a small buffer 78 of the embedded device, the buffer 78 having a capacity of 16 bytes in this example (significantly smaller than the 500+bytes length of the payload 72). Specifically, the protocol specific state machine 70 strips out from the payload 72 the character “G” from the type 73, the name “index.html” from the file 74, and the variables name “a” and “b” and their values “23” and “47” from the variables 75, since these are all that are needed by an embedded device. The remaining information shown in grey is discarded. The contents of the buffer 78 may then be passed to the embedded device for processing at 79.

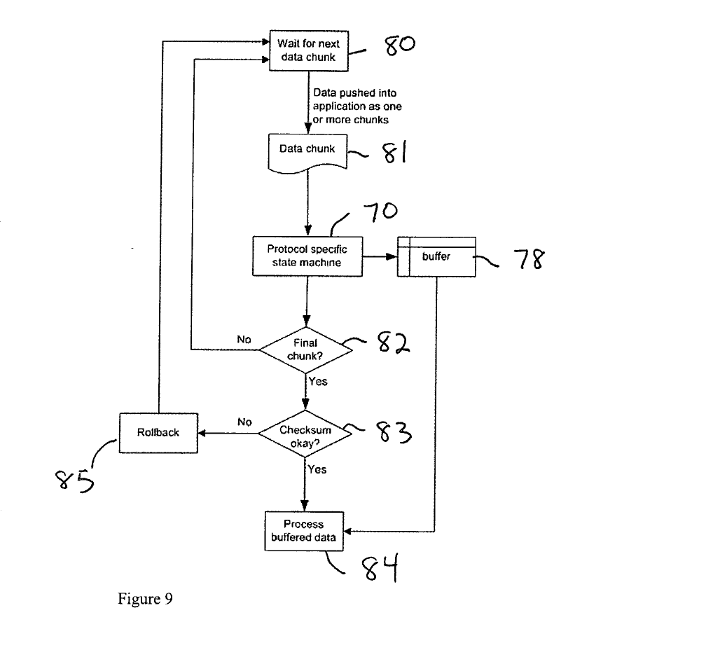

FIG. 9 is a flowchart illustrating the logical steps involved in the process introduced in FIG. 8. The protocol specific state machine 70 awaits data from one or more IP packets 71 at stage 80. When an IP packet 71 is received, data 81 is passed to the state machine 70 where only parts of the data 81 required by the embedded device (not shown) are stripped from the data 81 and passed to the buffer 78. The state machine 70 checks at stage 82 to see if any further data 81 is expected. If so, the process reverts to stage 80 to receive the further data 81. If not, a checksum 16, 17 is calculated at stage 83. Where the checksum 16, 17 is determined to be correct, the state machine 70 knows that data reception has been successful, and the contents of the buffer 78 is passed to the embedded device for processing at stage 84. Where the checksum 16, 17 is determined to be incorrect, the state machine 70 then rolls back at stage 85 to a checkpoint indicating the end of the last correctly received set of data 81 and awaits retransmission of the relevant IP packet 71 (cf. FIGS. 1 to 5).

The preferred features of the invention are applicable to all aspects of the invention and may be used in any possible combination.

Throughout the description and claims of this specification, the words “comprise” and “contain” and variations of the words, for example “comprising” and “comprises”, mean “including but not limited to”, and are not intended to (and do not) exclude other components, integers, moieties, additives or steps.

Glossary

| | |
|---|---|
| API | “Application Programmer Interface” - the set of functions made |
| | available by a software component to a programmer wishing to make |
| | use of the services it provides. |
| checkpoint | a saved state (such as partially receive known good data) in a form that |
| | the application can roll back to (e.g. to undo the effect of tentative |
| | acceptance of data which turns out to be incorrect). |
| checksum | a simple calculation performed over data to provide indication of |
| | corruption; when a system receives checksummed data it recalculates |
| | the checksum itself and if there is any discrepancy some error |
| | indication is raised. |
| datalink | the medium over which TCP/IP data is being transmitted |
| FTP | File Transfer Protocol, a mechanism of moving files between |
| | computers, typically implemented on top of the Transmission Control |
| | Protocol |
| HTTP | Hypertext Transfer Protocol, the protocol used to serve World Wide |
| | Web pages. Typically layered on top of the Transmission Control |
| | Protocol |
| Internet | formally, any structure formed of two or more networks on which |
| | computers speak the Internet Protocol. Informally, the world-wide |
| | agglomeration of such networks. |
| IP | the Internet Protocol |
| Microcontroller | a (typically small) microprocessor intended for use in control |
| | applications, with some on-board ROM, RAM and input/output |
| | devices. |
| MTU | Maximum Transmission Unit; the maximum length of a TCP/IP |
| | segment. This varies over different datalinks. |
| NAK | “Negative Acknowledge” - to refuse an offered option |
| PPP | the Point-to-Point protocol - a means of encapsulating and transmitting |
| | various networking protocols including the Internet Protocol suite over |
| | datalinks including asynchronous serial communication lines |
| RAM | Random Access Memory: “working store” in a computer system |
| | whose content may be both read and written during program execution |
| ROM | Read Only Memory: memory whose content may not be changed by |
| | program execution |
| segment | the unit of TCP/IP transmission; a packet of information containing |
| | host, destination and protocol information and a “payload” of data. |
| SQL | Structured Query Language, a means of describing and querying |
| | database systems |
| TCP | Transmission Control Protocol - a reliable end-to-end protocol layered |
| | on top of the Internet Protocol (IP) |
| TCP/IP stack | the suite of software allowing a computer to connect to the Internet |
| UDP | a User Datagram Protocol layered on top of the Internet Protocol |

1. An embedded computing device including a server application for receiving data transmitted to the embedded computing device under TCP/IP, wherein the server application is adapted to extract and buffer only predetermined portions of the transmitted data which are necessary for correct operation of the embedded computing device.

2. An embedded computing device as claimed in claim 1, adapted to transmit data under TCP/IP, which data is too large to be held by available RAM in the embedded computing device, wherein the embedded computing device is adapted to intermix dynamic data content which must be held in RAM with static data content which is held in ROM, and to separate the dynamic data held in RAM from the static data content held in ROM by way of a predetermined off-line calculation mechanism which generates discrete data packets each of which will fit into an MTU (Maximum Transmission Unit).

3. An embedded computing device as claimed in claim 1, adapted to negotiate PPP (Point-to-Point Protocol) options under TCP/IP by sending explicit reject and NAK (Negative AcKnowledge) messages as soon as a PPP option is received.

4. An embedded computing device as claimed in claim 2, adapted to utilise pre-computed TCP/IP communication session characteristics determined off-line, the characteristics comprising pre-calculated and stored partial checksums taken over static sections of data to be transmitted, wherein the embedded computing device combines pre-calculated partial checksum data with checksum data calculated for dynamic data content when transmitting data.

5. An embedded computing device as claimed in claim 2, including a server application and an off-line software tool, the embedded computing device being adapted send outgoing messages over a data link, wherein the off-line software tool is adapted to pre-segment the outgoing messages into segments which fit within a predetermined MTU limit of the data link so that the messages can be transmitted piece-wise without buffering.

6. An embedded computing device adapted to transmit data under TCP/IP, which data is too large to be held by available RAM in the embedded computing device, wherein the embedded computing device is adapted to intermix dynamic data content which must be held in RAM with static data content which is held in ROM, and to separate the dynamic data held in RAM from the static data content held in ROM by way of a predetermined off-line calculation mechanism which generates discrete data packets each of which will fit into an MTU (Maximum Transmission Unit).

7. An embedded computing device as claimed in claim 6, adapted to negotiate PPP (Point-to-Point Protocol) options under TCP/IP by sending explicit reject and NAK (Negative AcKnowledge) messages as soon as a PPP option is received.

8. An embedded computing device as claimed in claim 6, adapted to utilise pre-computed TCP/IP communication session characteristics determined off-line, the characteristics comprising pre-calculated and stored partial checksums taken over static sections of data to be transmitted, wherein the embedded computing device combines pre-calculated partial checksum data with checksum data calculated for dynamic data content when transmitting data.

9. An embedded computing device as claimed in claim 6, including a server application and an off-line software tool, the embedded computing device being adapted send outgoing messages over a data link, wherein the off-line software tool is adapted to pre-segment the outgoing messages into segments which fit within a predetermined MTU limit of the data link so that the messages can be transmitted piece-wise without buffering.

10. An embedded computing device adapted to utilise pre-computed TCP/IP communication session characteristics determined off-line, the characteristics comprising pre-calculated and stored partial checksums taken over static sections of data to be transmitted, wherein the embedded computing device combines pre-calculated partial checksum data with checksum data calculated for dynamic data content when transmitting data.

11. An embedded computing device including a server application and an off-line software tool, the embedded computing device being adapted send outgoing messages over a data link, wherein the off-line software tool is adapted to pre-segment the outgoing messages into segments which fit within a predetermined MTU limit of the data link so that the messages can be transmitted piece-wise without buffering.

12. An embedded computing device operating under TCP/IP in which an application task consumes no dynamic resources except when dealing with communications activity, wherein the embedded computing device is adapted to associate the application task as a servant for a connection such that the application task is passive until its execution is triggered by activity on the connection served.

13. An embedded computing device adapted for connection to a network by way of a plurality of connections, wherein the embedded computing device is programmed so as to make use of advanced knowledge of which of the plurality of connections it will use by default to listen for incoming data communication in order automatically to bind to those connections without any run-time application intervention.

14. A method of processing data transmitted to an embedded computing device under TCP/IP, wherein a server application provided in the embedded computing device is adapted to scan the transmitted data and to extract and buffer only predetermined portions of data which are necessary for correct operation of the embedded computing device.

15. A method according to claim 14, further comprising a step of transmitting data from the embedded computing device under TCP/IP, which data is too large to be held by available RAM in the embedded computing device, wherein dynamic data content which must be held in RAM is intermixed with static data content which is held in ROM, and wherein the dynamic data held in RAM is then separated from the static data content held in ROM by way of a predetermined off-line calculation mechanism which generates discrete data packets each of which will fit into an MTU (Maximum Transmission Unit).

16. A method according to claim 14, further comprising a step of negotiating PPP (Point-to-Point Protocol) options under TCP/IP in an embedded computing device by sending explicit reject and NAK (Negative AcKnowledge) messages as soon as a PPP option is received.

17. A method according to claim 15, wherein TCP/IP communication session characteristics are pre-computed off-line by pre-calculating and storing partial checksums over static sections of data to be transmitted, and wherein the embedded computing device then combines pre-calculated partial checksum data with checksum data calculated for dynamic data content when transmitting data.

18. A method according to claim 15, further comprising a step of sending messages from the embedded computing device over a data link, the embedded computing device including a server application and an off-line software tool, wherein the off-line software tool pre-segments outgoing messages into segments which fit within a predetermined MTU limit of the data link so that the messages can be transmitted piece-wise without buffering.

19. A method of transmitting data from an embedded computing device under TCP/IP, which data is too large to be held by available RAM in the embedded computing device, wherein dynamic data content which must be held in RAM is intermixed with static data content which is held in ROM, and wherein the dynamic data held in RAM is then separated from the static data content held in ROM by way of a predetermined off-line calculation mechanism which generates discrete data packets each of which will fit into an MTU (Maximum Transmission Unit).

20. A method according to claim 19, further comprising a step of negotiating PPP (Point-to-Point Protocol) options under TCP/IP in an embedded computing device by sending explicit reject and NAK (Negative AcKnowledge) messages as soon as a PPP option is received.

21. A method according to claim 19, wherein TCP/IP communication session characteristics are pre-computed off-line by pre-calculating and storing partial checksums over static sections of data to be transmitted, and wherein the embedded computing device then combines pre-calculated partial checksum data with checksum data calculated for dynamic data content when transmitting data.

22. A method according to claim 19, further comprising a step of sending messages from the embedded computing device over a data link, the embedded computing device including a server application and an off-line software tool, wherein the off-line software tool pre-segments outgoing messages into segments which fit within a predetermined MTU limit of the data link so that the messages can be transmitted piece-wise without buffering.

23. A method of operating an embedded computing device whereby TCP/IP communication session characteristics are pre-computed off-line by pre-calculating and storing partial checksums over static sections of data to be transmitted, and wherein the embedded computing device then combines pre-calculated partial checksum data with checksum data calculated for dynamic data content when transmitting data.

24. A method of sending messages from an embedded computing device over a data link, the embedded computing device including a server application and an off-line software tool, wherein the off-line software tool pre-segments outgoing messages into segments which fit within a predetermined MTU limit of the data link so that the messages can be transmitted piece-wise without buffering.

25. A method of operating an embedded computing device under TCP/IP such that an application task consumes no dynamic resources except when dealing with communications activity, wherein the embedded computing device is adapted to associate the application task as a servant for a connection such that the application task is passive until its execution is triggered by activity on the connection served.

26. A method of connecting an embedded computing device to a network by way of at least one of a plurality of connections, wherein the embedded computing device is programmed so as to make use of advanced knowledge of which of the plurality of connections it will use by default to listen for incoming data communication in order automatically to bind to those connections without any run-time application intervention.
